(19) United States
(12) Patent Application Publication
(10) Pub. No.: US 2026/0066181 A1
(43) Pub. Date: Mar. 5, 2026

(54) COIL COMPONENT

(71) Applicant: TDK CORPORATION, Tokyo (JP)

(72) Inventors: Munehiro TAKAKU, Tokyo (JP); Kazuya TOBITA, Tokyo (JP); Shinnosuke SUZUKI, Tokyo (JP); Tomohiro KAITO, Tokyo (JP)

(73) Assignee: TDK CORPORATION, Tokyo (JP)

(21) Appl. No.: 19/298,403

(22) Filed: Aug. 13, 2025

(30) Foreign Application Priority Data
Aug. 27, 2024 (JP) 2024-145852

(51) Int. Cl. H01F 27/28

(52) U.S. Cl. CPC H01F 27/2828

(57) ABSTRACT

A coil component includes an element body, an external conductor, a coil, and an internal conductor. The coil has a first wiring, a second wiring, and a third wiring. The third wiring includes a connecting body and a third conductor. The connecting body includes a first portion adjacent to the first wiring. The first portion includes a region overlapping the third conductor as viewed from the first direction. The connecting body does not overlap the third conductor as viewed from the first direction, and includes a second portion adjacent to the first wiring with the first portion positioned therebetween. An area of a region defined by an outer edge of the connecting body as viewed from the first direction is larger than an area of a region defined by an outer edge of the third conductor as viewed from the first direction.

### CROSS-REFERENCE TO RELATED APPLICATIONS

This application is based upon and claims the benefit of priority from Japanese Patent Application No. 2024-145852, filed on Aug. 27, 2024, the entire contents of which are incorporated herein by reference.

### BACKGROUND

### Field

The present invention relates to a coil component.

### Description of the Related Art

A known coil component includes an element body, a coil in the element body, an external conductor connected to the coil, and an internal conductor connecting the coil and the external conductor. For example, in the coil component disclosed in Japanese Patent Application Publication No. 2015-141945, the element body has a first main surface and a second main surface opposed to each other in a first direction. The external conductor is on the first main surface. The coil has a first wiring adjacent to the first main surface, a second wiring adjacent to the second main surface, and a third wiring. The third wiring connects the second wiring and the internal conductor.

### SUMMARY

An object of one aspect of the present invention is to provide a coil component that improves connection strength between a coil and an internal conductor and restrains an increase in stray capacitance.

A coil component according to one aspect of the present invention includes an element body, an external conductor, a coil, and an internal conductor. The element body has a first main surface and a second main surface opposed to each other in a first direction. The external conductor is exposed at the first main surface. The coil is in the element body. The internal conductor is disposed between the external conductor and the coil in the first direction, and connects the external conductor and the coil. The coil has a first wiring, a second wiring, and a third wiring. The first wiring includes at least one first conductor adjacent to the first main surface. The second wiring includes a plurality of second conductors adjacent to the second main surface and arranged in a second direction intersecting the first direction. The third wiring connects the internal conductor and a second conductor positioned at an end in the second direction among the plurality of second conductors. The third wiring includes a connecting body and a third conductor. The connecting body is positioned on the internal conductor and adjacent to the first wiring. The third conductor extends along the first direction between the connecting body and the second conductor positioned at the end. The connecting body includes a first portion and a second portion. The first portion is adjacent to the first wiring, and includes a region overlapping the third conductor as viewed from the first direction. The second portion does not overlap the third conductor as viewed from the first direction, and is adjacent to the first wiring with the first portion positioned between the second portion and the first wring. An area of a region defined by an outer edge of the connecting body as viewed from the first direction is larger than an area of a region defined by an outer edge of the third conductor as viewed from the first direction.

In the one aspect, the coil is connected to the internal conductor at the connecting body of the third wiring. A region where the third wiring and the internal conductor are in contact with each other in the configuration in which the third wiring includes the connecting body includes a region defined by an outer edge of the connecting body as viewed from the first direction. A region where the third wiring and the internal conductor are in contact with each other in the configuration in which the third wiring does not include the connecting body includes a region defined by an outer edge of the third conductor as viewed from the first direction. An area of a region defined by an outer edge of the connecting body as viewed from the first direction is larger than an area of a region defined by an outer edge of the third conductor as viewed from the first direction. Therefore, in the one aspect in which the connecting body and the internal conductor are connected, the connection strength between the coil and the internal conductor can be improved as compared with the configuration in which the third wiring that does not include the connecting body and the internal conductor are connected.

In the one aspect, the connecting body is adjacent to the first wiring. The first portion of the connecting body includes a region overlapping the third conductor as viewed from the first direction, and is adjacent to the first wiring. The second portion of the connecting body does not overlap the third conductor as viewed from the first direction. The second portion that does not overlap the third conductor is adjacent to the first wiring with the first portion positioned therebetween. The first portion is positioned between the first wiring and the second portion. Therefore, a distance between the first wiring and the second portion is larger than a distance between the first wiring and the first portion. In the configuration in which a portion that does not overlap the third conductor is positioned only between the first wiring and the first portion, a distance between the portion that does not overlap the third conductor and the first wiring is smaller than a distance between the first portion and the first wiring. Therefore, as compared with the configuration in which the portion that does not overlap the third conductor is positioned only between the first wiring and the first portion, the one aspect in which the second portion is adjacent to the first wiring with the first portion positioned therebetween is less likely to cause stray capacitance between the third wiring and the first wiring. As a result, the one aspect can restrain an increase in stray capacitance.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter.

However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view illustrating a coil component according to an embodiment;

FIG. 2 is a side surface view of the coil component according to the present embodiment as viewed from a side surface;

FIG. 3 is another side surface view of the coil component according to the present embodiment as viewed from a side surface;

FIG. 4 is a plan view of the coil component according to the present embodiment as viewed from a main surface;

FIG. 5 is a diagram illustrating a cross-sectional configuration of the coil component according to the present embodiment;

FIG. 6 is a side surface view of the coil component according to a modification as viewed from a side surface; and

FIG. 7 is a diagram illustrating a cross-sectional configuration of the coil component according to the modification.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

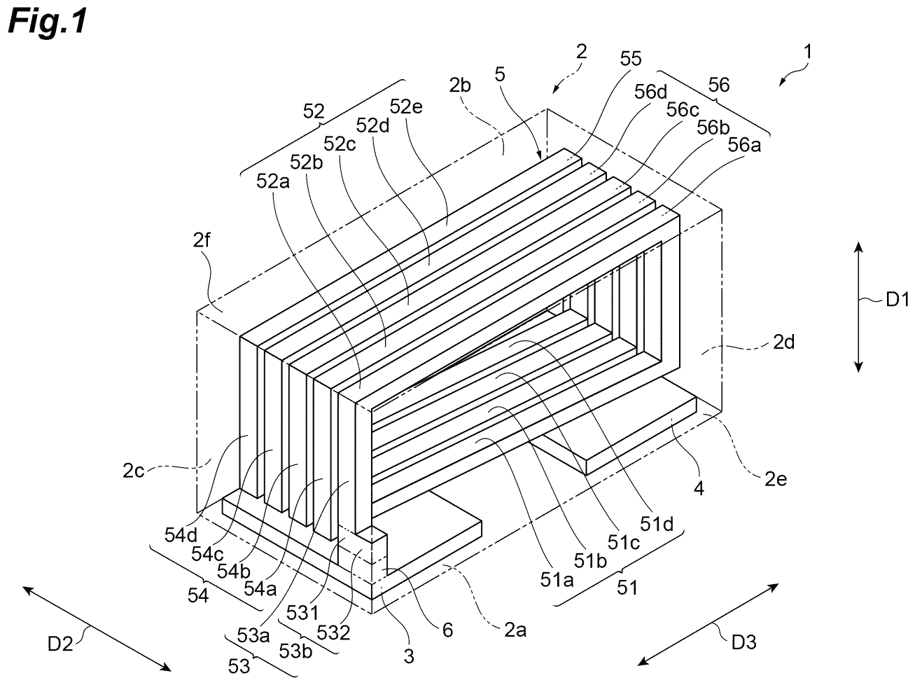

With reference to FIGS. 1 to 5, a configuration of a coil component 1 according to the present embodiment will be described.

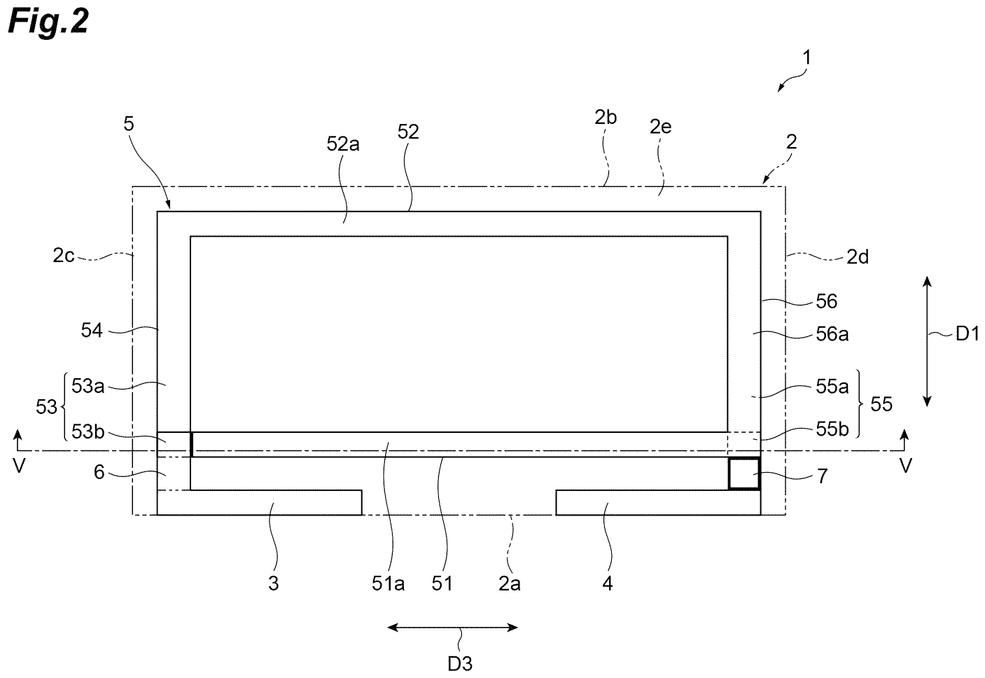

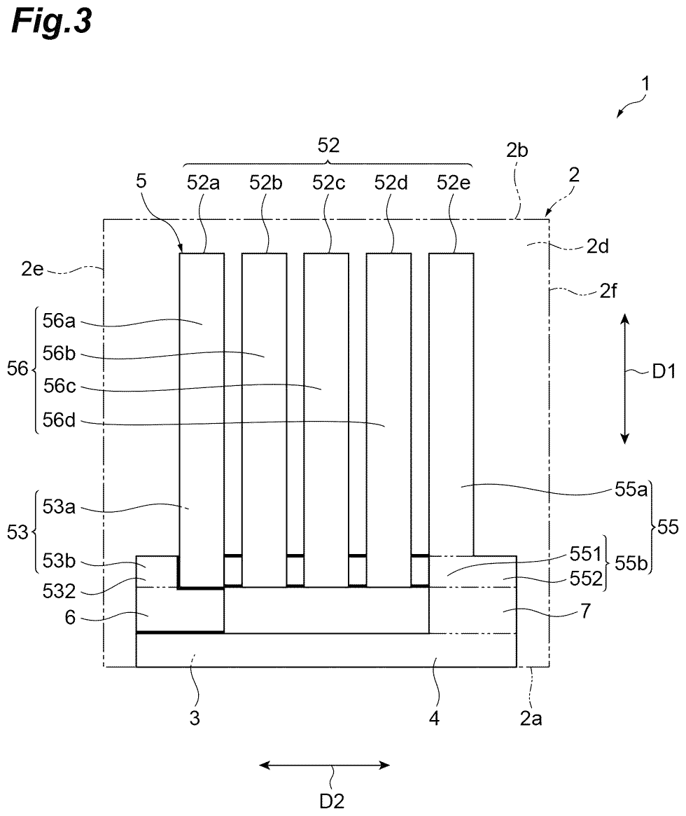

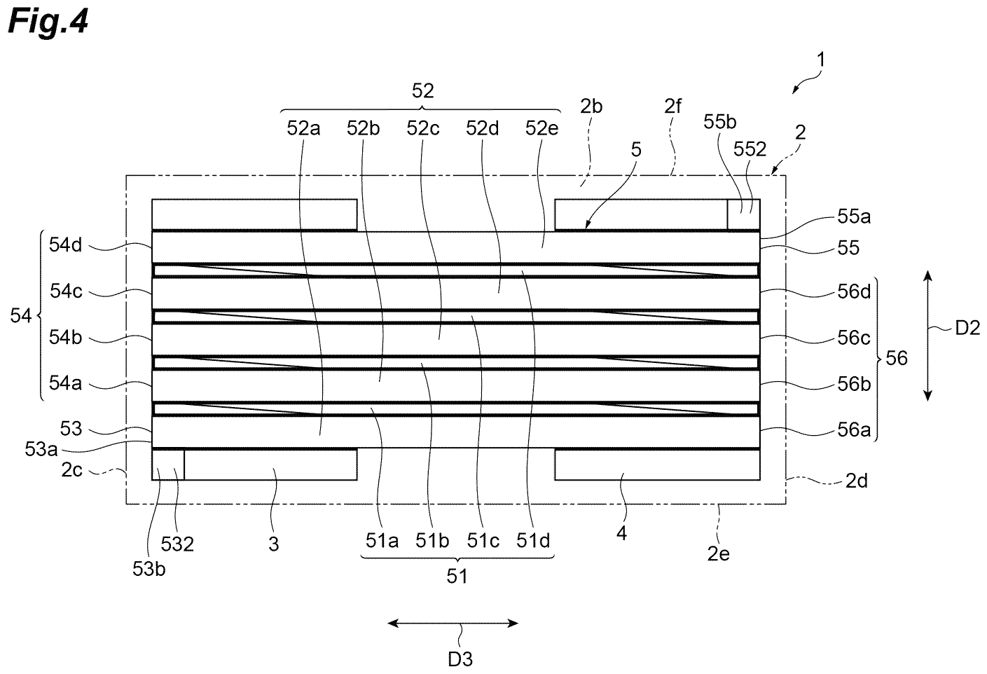

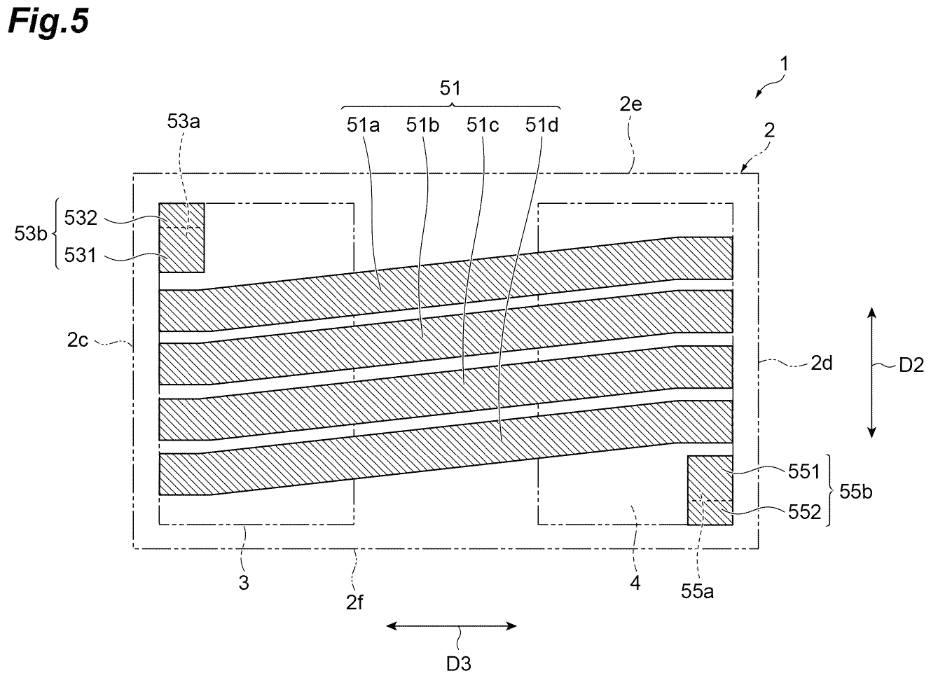

FIG. 1 is a perspective view illustrating a coil component according to the present embodiment. FIG. 2 is a side surface view of the coil component according to the present embodiment as viewed from a side surface 2e illustrated in FIG. 1. FIG. 3 is a side surface view of the coil component according to the present embodiment as viewed from a side surface 2d illustrated in FIG. 1. FIG. 4 is a plan view of the coil according to the present embodiment as viewed from a main surface 2b illustrated in FIG. 1. FIG. 5 is a diagram illustrating a cross-sectional configuration of the coil component according to the present embodiment taken along line V-V illustrated in FIG. 2. The coil component 1 according to the present embodiment is solder-mounted to an electronic device. The electronic device includes, for example, a circuit board or an electronic component. As illustrated in FIGS. 1 to 5, the coil component 1 includes an element body 2, an external conductor 3, an external conductor 4, a coil 5, an internal conductor 6, and an internal conductor 7.

In FIGS. 1 to 5, and FIGS. 6 and 7, for the sake of explanation, the outline of the element body 2 is illustrated by a two-dot chain line, and the configuration other than the element body 2 is illustrated by a solid line. The actual element body 2 is solid. Therefore, in the actual coil component 1, the configuration in the element body 2 is not always visually recognized.

The element body 2 has a rectangular parallelepiped shape. The rectangular parallelepiped shape includes a rectangular parallelepiped shape in which corner portions or ridge line portions are chamfered and rounded. The element body 2 has a main surface 2a and a main surface 2b opposed to each other, a side surface 2c and a side surface 2d opposed to each other, and a side surface 2e and a side surface 2f opposed to each other. Each of the main surfaces 2a and 2b, side surfaces 2c and 2d, and side surfaces 2e and 2f has a rectangular shape. The side surfaces 2c and 2d, and the side surfaces 2e and 2f are connected to the main surfaces 2a and 2b. The side surfaces 2c and 2d are each adjacent to the side surfaces 2e and 2f, with the corner portions or the ridge line portions positioned between the adjacent side surfaces. When the coil component 1 is solder-mounted on the electronic device, the main surface 2a faces the electronic device to which the coil component 1 is to be mounted.

The main surface 2a and the main surface 2b opposed to each other in a direction D1. For example, the direction D1 includes a first direction. In a case where the main surface 2a includes a first main surface, the main surface 2b includes a second main surface. The side surfaces 2e and 2f opposed to each other in a direction D2. The direction D2 intersects the direction D1. For example, the direction D2 includes a second direction. The side surfaces 2c and 2d opposed to each other in a direction D3. The direction D3 intersects the direction D1 and the direction D2. For example, the direction D3 includes a third direction. In the present embodiment, the direction D1, the direction D2, and the direction D3 are perpendicular to one another. In one example, a length of the element body 2 in the direction D3 may be larger than a length of the element body 2 in the direction D2. The length of the element body 2 in the direction D3 may be larger than the length of the element body 2 in the direction D1.

The element body 2 includes a plurality of insulator layers having electrical insulation properties. In the present embodiment, the element body 2 includes a plurality of insulator layers laminated in the direction D1. In the actual element body 2, the plurality of insulator layers is integrated to such an extent that boundaries between the layers cannot be visually recognized. Each of the plurality of insulator layers has, for example, a rectangular shape as viewed from the direction D1.

Each of the insulator layers includes, for example, a sintered body of a ceramic green sheet containing a ferrite material. The ferrite material includes, for example, a Ni—Cu—Zn-based ferrite material, a Ni—Cu—Zn—Mg-based ferrite material, or a Ni—Cu-based ferrite material. Each insulator layer may include an Fe alloy. Each insulator layer may include a non-magnetic material. The non-magnetic material includes, for example, a glass ceramic material or a dielectric material. Each insulator layer may include a resin material. The resin material includes, for example, at least one selected from a liquid crystal polymer, a polyimide resin, crystalline polystyrene, an epoxy resin, an acrylic resin, a bismaleimide-based resin, and a fluorine-based resin. The resin material includes, for example, a filler. The filler includes, for example, an inorganic filler. The inorganic filler includes silica. The resin material may not include a filler.

The external conductors 3 and 4 are exposed at the main surface 2a. In a case where the coil component 1 is solder-mounted to the electronic device, the external conductors 3 and 4 are connected to terminals of the electronic device. The external conductors 3 and 4 are arranged away from each other in the direction D3. The external conductor 3 is disposed closer to the side surface 2c, and the external conductor 4 is disposed closer to the side surface 2d. In the present embodiment, the external conductors 3 and 4 are respectively disposed in a pair of recesses formed in the main surface 2a. The external conductors 3 and 4 are not exposed at the side surfaces 2c, 2d, 2e, and 2f. As viewed from the direction D1, the external conductors 3 and 4 are positioned away from corner portions or ridge line portions between the main surface 2a and the side surfaces 2c, 2d, 2e and 2f. As viewed from the direction D1, each of the external conductors 3 and 4 has a rectangular shape. Each of the external conductors 3 and 4 has long sides along the direction D2 and short sides along the direction D3.

Each of the external conductors 3 and 4 includes a conductive material. The conductive material includes, for example, Ag, Pd, Cu, or Al. The conductive material includes, for example, an Ag—Pd alloy, an Ag—Cu alloy, an Ag—Au alloy, or an Ag—Pt alloy. Each of the external conductors 3 and 4 includes, for example, a Ni plating film, a Sn plating film, a Cu plating film, or an Au plating film. Each of the external conductors 3 and 4 may have a multilayer structure of these plating films, and may include a Ni plating film and a Sn plating film formed on the Ni plating film. The plating film are formed by, for example, electroplating or electroless plating.

The coil 5 is disposed in the element body 2. A coil axis of the coil 5 is provided along the direction D2. The coil 5 has a plurality of wirings extending to surround the coil axis. The coil 5 has a wiring 51, a wiring 52, a wiring 53, a wiring 54, a wiring 55, and a wiring 56. As illustrated in FIG. 2, the coil 5 has a rectangular shape as viewed from the direction D2. The coil 5 includes the above-described conductive material. The coil 5, the internal conductors 6 and 7, and the external conductors 3 and 4 are electrically connected.

The wiring 51 is adjacent to the main surface 2a. The wiring 51 includes at least one conductor. The wiring 51 includes a conductor 51a, a conductor 51b, a conductor 51c, and a conductor 51d. The conductors 51a, 51b, 51c, and 51d extend along the direction D3. The conductors 51a, 51b, 51c, and 51d are arranged in the direction D2. The conductor 51a is positioned at an end closer to the side surface 2e in the direction D2, and the conductor 51d is positioned at an end closer to the side surface 2f in the direction D2. For example, the wiring 51 includes a first wiring, and the conductors 51a, 51b, 51c, and 51d include at least one first conductor.

The wiring 52 is adjacent to the main surface 2b. The wiring 52 includes a plurality of conductors. The wiring 52 includes a conductor 52a, a conductor 52b, a conductor 52c, a conductor 52d, and a conductor 52e. Each of the conductors 52a, 52b, 52c, 52d, and 52e extends along the direction D3. The conductors 52a, 52b, 52c, 52d, and 52e are arranged in the direction D2. The conductor 52a is positioned at an end closer to the side surface 2e in the direction D2, and the conductor 52e is positioned at an end closer to the side surface 2f in the direction D2. For example, the wiring 52 includes a second wiring, and the conductors 52a, 52b, 52c, 52d, and 52e include a plurality of second conductors. The conductors 52a and 52e are positioned at ends in the direction D2.

The wiring 53 connects the conductor 52a and the internal conductor 6. The wiring 53 is connected to the external conductor 3 with the internal conductor 6 positioned therebetween. The wiring 53 is adjacent to the side surface 2c. In the coil 5, the wiring 53 is positioned at an end close to the side surface 2e in the direction D2. For example, the wiring 53 includes a third wiring.

The wiring 53 includes a conductor 53a and a connecting body 53b. The conductor 53a is connected to the conductor 52a. The conductor 53a extends along the direction D1 between the conductor 52a and the connecting body 53b. For example, the conductor 53a of the wiring 53 is close to the main surface 2b than the wiring 51 in the direction D1. The connecting body 53b is connected to the internal conductor 6. The connecting body 53b is positioned on the internal conductor 6. The connecting body 53b is adjacent to the wiring 51. As illustrated in FIG. 5, the connecting body 53b is adjacent to the wiring 51 in the cross section perpendicular to the direction D1. The connecting body 53b is adjacent to the wiring 51 in a direction perpendicular to the direction D1. For example, the connecting body 53b is adjacent to the wiring 51 in the direction D2. For example, the connecting body 53b is adjacent to the wiring 51 in the direction D3. Specifically, the connecting body 53b is adjacent to the conductor 51a among the plurality of conductors 51a, 51b, 51c, and 51d. The shortest distance between the connecting body 53b and the main surface 2b may be equal to the shortest distance between the wiring 51 and the main surface 2b. For example, the conductor 53a includes a third conductor.

The wiring 55 connects the conductor 52e and the internal conductor 7. The wiring 55 is connected to the external conductor 4 with the internal conductor 7 positioned therebetween. The wiring 55 is adjacent to the side surface 2d. In the coil 5, the wiring 55 is positioned at an end close to the side surface 2f in the direction D2. For example, the wiring 55 includes a third wiring.

The wiring 55 includes a conductor 55a and a connecting body 55b. The conductor 55a is connected to the conductor 52e. The conductor 55a extends along the direction D1 between the conductor 52e and the connecting body 55b. For example, the conductor 55a of the wiring 55 is closer to the main surface 2b than the wiring 51 in the direction D1. The connecting body 55b is connected to the internal conductor 7. The connecting body 55b is positioned on the internal conductor 7. The connecting body 55b is adjacent to the wiring 51. As illustrated in FIG. 5, the connecting body 55b is adjacent to the wiring 51 in the cross section perpendicular to the direction D1. The connecting body 55b is adjacent to the wiring 51 in a direction perpendicular to the direction D1. For example, the connecting body 55b is adjacent to the wiring 51 in the direction D2. For example, the connecting body 55b is adjacent to the wiring 51 in the direction D3. Specifically, the connecting body 55b is adjacent to the conductor 51d among the plurality of conductors 51a, 51b, 51c, and 51d. The shortest distance between the connecting body 55b and the main surface 2b may be equal to the shortest distance between the wiring 51 and the main surface 2b. For example, the conductor 55a includes a third conductor.

The wiring 54 connects the wiring 51 and the wiring 52. The wiring 54 is adjacent to the side surface 2c. The wiring 54 includes at least one conductor. The wiring 54 includes a conductor 54a, a conductor 54b, a conductor 54c, and a conductor 54d. As illustrated in FIG. 4, the shortest distance between the side surface 2c and the conductors 54a, 54b, 54c, and 54d may be equal to the shortest distance between the external conductor 3 and the side surface 2c. The conductors 54a, 54b, 54c, and 54d extend along the direction D1. The conductors 54a, 54b, 54c, and 54d are arranged in the direction D2. The conductor 54d is positioned at an end close to the side surface 2f. The conductor 54a is adjacent to the conductor 53a in the direction D2.

The wiring 56 connects the wiring 51 and the wiring 52. The wiring 56 is adjacent to the side surface 2d. The wiring 56 includes at least one conductor. The wiring 56 includes a conductor 56a, a conductor 56b, a conductor 56c, and a conductor 56d. As illustrated in FIG. 4, the shortest distance between the side surface 2d and the conductors 56a, 56b, 56c, and 56d may be equal to the shortest distance between the external conductor 4 and the side surface 2d. The conductors 56a, 56b, 56c, and 56d extend along the direction D1. The conductors 56a, 56b, 56c, and 56d are arranged in the direction D2. The conductor 56a is positioned at an end close to the side surface 2e. The conductor 56d is adjacent to the conductor 55a in the direction D2.

For example, the wirings 54 and 56 include a fifth wiring, and the conductors 54a, 54b, 54c, 54d, 56a, 56b, 56c, and 56d include at least one fifth conductor. In the present specification, the term “equal” does not necessarily mean that values coincide with each other. Even in a case where values include slight differences, manufacturing errors, or measurement errors within a preset range, the values may be regarded as being equal to each other.

The conductor 53a and the connecting body 53b connect the internal conductor 6 and the conductor 52a. The conductor 56a connects the conductor 52a and the conductor 51a. The conductor 54a connects the conductor 51a and the conductor 52b. The conductor 56b connects the conductor 52b and the conductor 51b. The conductor 54b connects the conductor 51b and the conductor 52c. The conductor 56c connects the conductor 52c and the conductor 51c. The conductor 54c connects the conductor 51c and the conductor 52d. The conductor 56d connects the conductor 52d and the conductor 51d. The conductor 54d connects the conductor 51d and the conductor 52e. The conductor 55a and the connecting body 55b connect the conductor 52e and the internal conductor 7.

The internal conductors 6 and 7 are disposed between the external conductors 3 and 4 and the coil 5 in the direction D1. The internal conductors 6 and 7 connect the external conductors 3 and 4 to the coil 5. The internal conductors 6 and 7 are not adjacent to the wiring 51. In the cross section perpendicular to the direction D1, the internal conductors 6 and 7 are not adjacent to the wiring 51. The internal conductors 6 and 7 are not adjacent to the wiring 51 in the direction perpendicular to the direction D1. The internal conductors 6 and 7 include, for example, the above-described conductive material.

The internal conductor 6 is disposed between the external conductor 3 and the coil 5 in the direction D1. Specifically, the internal conductor 6 is disposed between the external conductor 3 and the wiring 53 of the coil 5 in the direction D1. The internal conductor 6 connects the external conductor 3 and the wiring 53 of the coil 5. In the actual coil component 1, the wiring 53 and the internal conductor 6 are integrated to such an extent that a boundary between the wiring 53 and the internal conductor 6 cannot be visually recognized. For example, the internal conductor 6 is closer to the main surface 2a than the wiring 51 in the direction D1, among the wiring 53 and the internal conductor 6.

The internal conductor 7 is disposed between the external conductor 4 and the coil 5 in the direction D1. Specifically, the internal conductor 7 is disposed between the external conductor 4 and the wiring 55 of the coil 5 in the direction D1. The internal conductor 7 connects the external conductor 4 and the wiring 55 of the coil 5. In the actual coil component 1, the wiring 55 and the internal conductor 7 are integrated to such an extent that a boundary between the wiring 55 and the internal conductor 7 cannot be visually recognized. For example, the internal conductor 7 is closer to the main surface 2a than the wiring 51 in the direction D1, among the wiring 55 and the internal conductor 7.

The connecting body 53b includes a portion 531 and a portion 532. The portion 531 includes a region overlapping the conductor 53a as viewed from the direction D1, and is adjacent to the wiring 51. In the present embodiment, the portion 531 is formed of only the region overlapping the conductor 53a as viewed from the direction D1. The portion 532 is adjacent to the wiring 51 with the portion 531 positioned therebetween. As viewed from the direction D1, the portion 532 does not overlap the conductor 53a. As viewed from the direction D1, the portion 532 is spaced apart from the conductor 53a. The portion 531 is positioned between the portion 532 and the wiring 51. For example, the portion 531 is positioned between the portion 532 and the wiring 51 in the direction D2. As illustrated in FIG. 5, an area of a region defined by an outer edge of the connecting body 53b as viewed from the direction D1 is larger than an area of a region defined by an outer edge of the conductor 53a as viewed from the direction D1. The area of the region defined by the outer edge of the connecting body 53b as viewed from the direction D1 is the sum of an area of the portion 531 as viewed from the direction D1 and an area of the portion 532 as viewed from the direction D1. For example, the portion 531 includes a first portion, and the portion 532 includes a second portion.

A distance between the connecting body 53b and the main surface 2b is a distance between the portion 532 and the wiring 51. A boundary between the conductor 53a and the connecting body 53b in the wiring 53 may be defined by, for example, a virtual plane including a surface of the portion 532 facing the main surface 2b.

The width between the outer edge of the conductor 53a as viewed from the direction D1 and the outer edge of the connecting body 53b as viewed from the direction D1 is the largest at the portion 532. The “width” is, for example, the shortest distance between a point positioned on the outer edge of the connecting body 53b as viewed from the direction D1 and the outer edge of the conductor 53a as viewed from the direction D1.

In the present embodiment, a region of the connecting body 53b that does not overlap the conductor 53a as viewed from the direction D1 is not positioned between the wiring 51 and a region of the connecting body 53b that overlaps the conductor 53a as viewed from the direction D1. The region of the connecting body 53b that is spaced apart from the conductor 53a as viewed from the direction D1 is disposed only at a position farther from the wiring 51 than the region of the connecting body 53b that overlaps the conductor 53a as viewed from the direction D1. The portion 531 does not include a region that does not overlap the conductor 53a as viewed from the direction D1.

A surface of the conductor 53a facing the side surface 2f is flush with a surface of the connecting body 53b facing the side surface 2f. A surface of the connecting body 53b facing the side surface 2f is flush with a surface of the internal conductor 6 facing the side surface 2f. A surface of the conductor 53a facing the side surface 2d is flush with a surface of the connecting body 53b facing the side surface 2d. A surface of the connecting body 53b facing the side surface 2d is flush with a surface of the internal conductor 6 facing the side surface 2d.

An outer edge of the conductor 53a facing the side surface 2f as viewed from the direction D1 and an outer edge of the connecting body 53b facing the side surface 2f as viewed from the direction D1 overlap each other. An outer edge of the conductor 53a facing the side surface 2d as viewed from the direction D1 and an outer edge of the connecting body 53b facing the side surface 2d as viewed from the direction D1 overlap each other. As a result, the width between the outer edge of the conductor 53a as viewed from the direction D1 and the outer edge of the connecting body 53b as viewed from the direction D1 is zero in the portion 531.

The portion 532 includes a region adjacent to the wiring 51 with the portion 531 positioned therebetween in the direction D2. The portion 532 is formed of only the region adjacent to the wiring 51 with the portion 531 positioned therebetween in the direction D2. Since the portion 532 does not include a region adjacent to the wiring 51 with the portion 531 positioned therebetween in the direction D3, a length of the region of the portion 532 adjacent to the wiring 51 with the portion 531 positioned therebetween in the direction D3 is zero. A length of the region of the portion 532 in the direction D2 adjacent to the wiring 51 with the portion 531 positioned therebetween in the direction D2, is larger than a length of the region of the portion 532 in the direction D3 adjacent to the wiring 51 with the portion 531 positioned therebetween in the direction D3.

A surface of the conductor 53a facing the side surface 2c is flush with a surface of the connecting body 53b facing the side surface 2c. A surface of the connecting body 53b facing the side surface 2c is flush with a surface of the internal conductor 6 facing the side surface 2c. A surface of the internal conductor 6 facing the side surface 2c is flush with a surface of the external conductor 3 facing the side surface 2c.

An outer edge of the conductor 53a facing the side surface 2c as viewed from the direction D1 and an outer edge of the connecting body 53b facing the side surface 2c as viewed from the direction D1 overlap each other.

The shortest distance between the connecting body 53b and the side surface 2c may be equal to the shortest distance between the wiring 51 and the side surface 2c. A surface of the connecting body 53b facing the side surface 2e is flush with a surface of the internal conductor 6 facing the side surface 2e. The surface of the internal conductor 6 facing the side surface 2e is flush with a surface of the external conductor 3 facing the side surface 2e.

The connecting body 55b includes a portion 551 and a portion 552. The portion 551 includes a region overlapping the conductor 55a as viewed from the direction D1, and is adjacent to the wiring 51. In the present embodiment, the portion 551 is formed of only the region overlapping the conductor 55a as viewed from the direction D1. The portion 552 is adjacent to the wiring 51 with the portion 551 positioned therebetween. As viewed from the direction D1, the portion 552 does not overlap the conductor 55a. As viewed from the direction D1, the portion 552 is spaced apart from the conductor 55a. The portion 551 is positioned between the portion 552 and the wiring 51. For example, the portion 551 is positioned between the portion 552 and the wiring 51 in the direction D2. As illustrated in FIG. 5, an area of a region defined by an outer edge of the connecting body 55b as viewed from the direction D1 is larger than an area of a region defined by an outer edge of the conductor 55a as viewed from the direction D1. The area of the region defined by the outer edge of the connecting body 55b as viewed from the direction D1 is the sum of an area of the portion 551 as viewed from the direction D1 and an area of the portion 552 as viewed from the direction D1. For example, the portion 551 includes a first portion, the portion 552 includes a second portion.

A distance between the connecting body 55b and the main surface 2b is a distance between the portion 552 and the wiring 51. A boundary between the conductor 55a and the connecting body 55b in the wiring 51 may be defined by, for example, a virtual plane including a surface of the portion 552 facing the main surface 2b.

The width between the outer edge of the conductor 55a as viewed from the direction D1 and the outer edge of the connecting body 55b as viewed from the direction D1 is the largest at the portion 552. The “width” is, for example, the shortest distance between a point positioned on the outer edge of the connecting body 55b as viewed from the direction D1 and the outer edge of the conductor 55a as viewed from the direction D1.

In the present embodiment, a region of the connecting body 55b that does not overlap the conductor 55a as viewed from the direction D1 is not positioned between the wiring 51 and a region of the connecting body 55b that overlaps the conductor 55a as viewed from the direction D1. The region of the connecting body 55b that is spaced apart from the conductor 55a as viewed from the direction D1 is disposed only at a position farther from the wiring 51 than the region of the connecting body 55b that overlaps the conductor 55a as viewed from the direction D1. The portion 551 does not include a region that does not overlap the conductor 55a as viewed from the direction D1.

A surface of the conductor 55a facing the side surface 2e is flush with a surface of the connecting body 55b facing the side surface 2e. A surface of the connecting body 55b facing the side surface 2e is flush with a surface of the internal conductor 7 facing the side surface 2e. A surface of the conductor 55a facing the side surface 2c is flush with a surface of the connecting body 55b facing the side surface 2c. A surface of the connecting body 55b facing the side surface 2c is flush with a surface of the internal conductor 7 facing the side surface 2c.

An outer edge of the conductor 55a facing the side surface 2e as viewed from the direction D1 and an outer edge of the connecting body 55b facing the side surface 2e as viewed from the direction D1 overlap each other. An outer edge of the conductor 55a facing the side surface 2c as viewed from the direction D1 and an outer edge of the connecting body 55b facing the side surface 2c as viewed from the direction D1 overlap each other. As a result, the width between the outer edge of the conductor 55a as viewed from the direction D1 and the outer edge of the connecting body 55b as viewed from the direction D1 is zero in the portion 551.

The portion 552 includes a region adjacent to the wiring 51 with the portion 551 positioned therebetween in the direction D2. The portion 552 is formed of only the region adjacent to the wiring 51 with the portion 551 positioned therebetween in the direction D2. Since the portion 552 does not include a region adjacent to the wiring 51 with the portion 551 positioned therebetween in the direction D3, a length of the region of the portion 552 adjacent to the wiring 51 with the portion 551 positioned therebetween in the direction D3 is zero. A length of the region of the portion 552 in the direction D2 adjacent to the wiring 51 with the portion 551 positioned therebetween in the direction D2, is larger than a length of the region of the portion 552 in the direction D3 adjacent to the wiring 51 with the portion 551 positioned therebetween in the direction D3.

A surface of the conductor 55a facing the side surface 2d is flush with a surface of the connecting body 55b facing the side surface 2d. A surface of the connecting body 55b facing the side surface 2d is flush with a surface of the internal conductor 7 facing the side surface 2d. The surface of the internal conductor 7 facing the side surface 2d is flush with a surface of the external conductor 3 facing the side surface 2d.

An outer edge of the conductor 55a facing the side surface 2d as viewed from the direction D1 and an outer edge of the connecting body 55b facing the side surface 2d as viewed from the direction D1 overlap each other.

The shortest distance between the connecting body 55b and the side surface 2d may be equal to the shortest distance between the wiring 51 and the side surface 2d. A surface of the connecting body 55b facing the side surface 2f is flush with a surface of the internal conductor 7 facing the side surface 2f. The surface of the internal conductor 7 facing the side surface 2f is flush with a surface of the external conductor 3 facing the side surface 2f.

The wiring 51 is positioned between the portion 531 and the portion 551. The portions 532 and 552 are not positioned between the portions 531 and 551. At least a part of the portion 531 and at least a part of the portion 551 are positioned between the portion 532 and the portion 552.

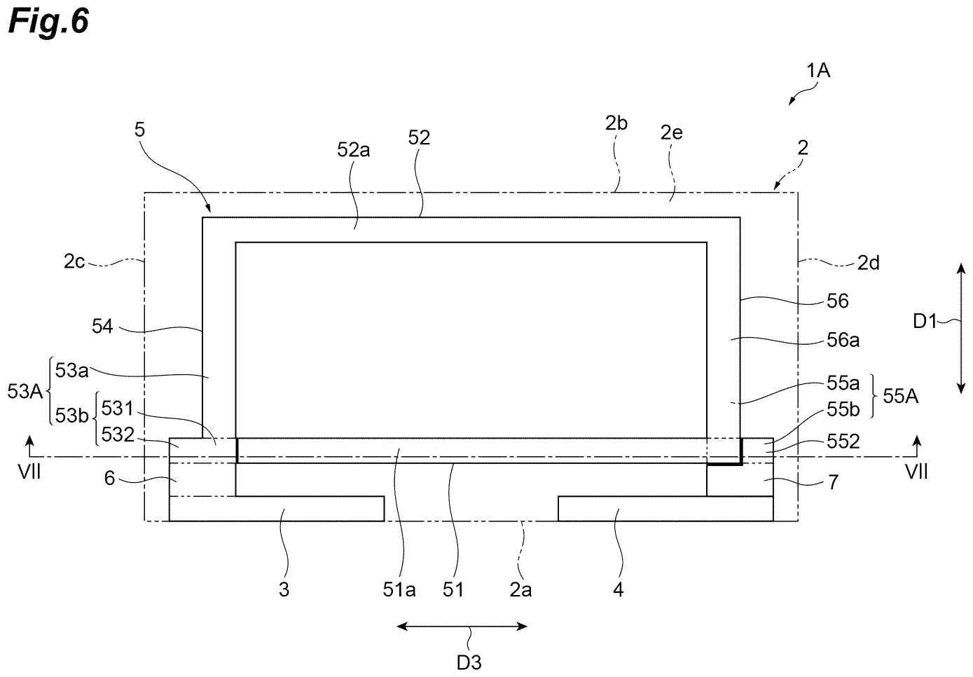

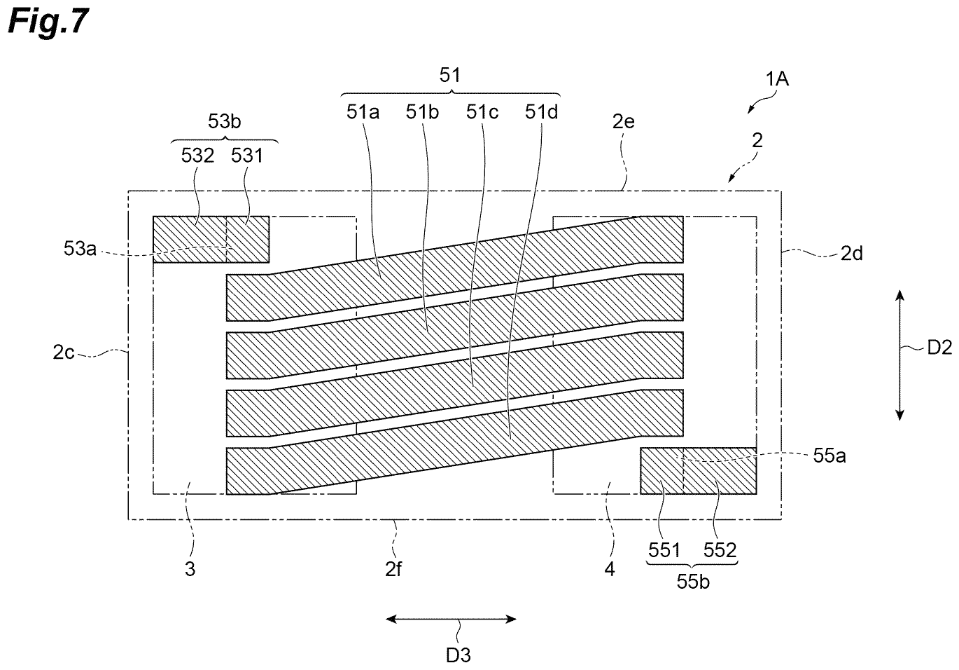

Next, with reference to FIGS. 6 and 7, a configuration of a coil component 1A according to a modification of the present embodiment will be described. In the coil component 1A according to the modification, the coil 5 has wirings 53A and 55A instead of the wirings 53 and 55. FIG. 6 is a side surface view of the coil component according to the modification as viewed from the side surface 2e. FIG. 7 is a diagram illustrating a configuration of the cross section of the coil component according to the modification taken along line VII-VII illustrated in FIG. 6. Hereinafter, differences between the embodiment described above and the present modification will be mainly described, and the redundant description will not be repeated as appropriate.

In the wiring 53A, the portion 531 is positioned between the portion 532 and the wiring 51 in the direction D3. The portion 532 includes a region adjacent to the wiring 51 with the portion 531 positioned therebetween in the direction D3. The portion 532 is formed of only the region adjacent to the wiring 51 with the portion 531 positioned therebetween in the direction D3. Since the portion 532 does not include a region adjacent to the wiring 51 with the portion 531 positioned therebetween in the direction D2, a length of the region of the portion 532 adjacent to the wiring 51 with the portion 531 positioned therebetween in the direction D2 is zero. A length of the region of the portion 532 in the direction D3 adjacent to the wiring 51 with the portion 531 positioned therebetween in the direction D3, is larger than a length of the region of the portion 532 in the direction D2 adjacent to the wiring 51 with the portion 531 positioned therebetween in the direction D2.

In the coil component 1A, a surface of the conductor 53a facing the side surface 2e is flush with a surface of the connecting body 53b facing the side surface 2e. A surface of the connecting body 53b facing the side surface 2e is flush with a surface of the internal conductor 6 facing the side surface 2e. The surface of the internal conductor 6 facing the side surface 2e is flush with a surface of the external conductor 3 facing the side surface 2e.

An outer edge of the conductor 53a facing the side surface 2e as viewed from the direction D1 and an outer edge of the connecting body 53b facing the side surface 2e as viewed from the direction D1 overlap each other.

The shortest distance between the connecting body 53b and the side surface 2e may be equal to the shortest distance between the wiring 51 and the side surface 2e. A surface of the connecting body 53b facing the side surface 2c is flush with a surface of the internal conductor 6 facing the side surface 2c. A surface of the internal conductor 6 facing the side surface 2c is flush with a surface of the external conductor 3 facing the side surface 2c.

In the wiring 55A, the portion 551 is positioned between the portion 552 and the wiring 51 in the direction D3. The portion 552 includes a region adjacent to the wiring 51 with the portion 551 positioned therebetween in the direction D3. The portion 552 is formed of only the region adjacent to the wiring 51 with the portion 551 positioned therebetween in the direction D3. Since the portion 552 does not include a region adjacent to the wiring 51 with the portion 551 positioned therebetween in the direction D2, a length of the region of the portion 552 adjacent to the wiring 51 with the portion 551 positioned therebetween in the direction D2 is zero. A length of the region of the portion 552 in the direction D3 adjacent to the wiring 51 with the portion 551 positioned therebetween in the direction D3, is larger than a length of the region of the portion 552 in the direction D2 adjacent to the wiring 51 with the portion 551 positioned therebetween in the direction D2.

In the coil component 1A, a surface of the conductor 55a facing the side surface 2f is flush with a surface of the connecting body 55b facing the side surface 2f. A surface of the connecting body 55b facing the side surface 2f is flush with a surface of the internal conductor 7 facing the side surface 2f. The surface of the internal conductor 7 facing the side surface 2f is flush with a surface of the external conductor 3 facing the side surface 2f.

An outer edge of the conductor 55a facing the side surface 2f as viewed from the direction D1 and an outer edge of the connecting body 55b facing the side surface 2f as viewed from the direction D1 overlap each other.

The shortest distance between the connecting body 55b and the side surface 2f may be equal to the shortest distance between the wiring 51 and the side surface 2f. A surface of the connecting body 55b facing the side surface 2d is flush with a surface of the internal conductor 7 facing the side surface 2d. The surface of the internal conductor 7 facing the side surface 2d is flush with a surface of the external conductor 3 facing the side surface 2d.

As described above, the coil 5 is connected to the internal conductors 6 and 7 at the connecting bodies 53b and 55b of the wirings 53 and 55. The respective regions where the wirings 53 and 55 and the internal conductors 6 and 7 are in contact with each other in the coil components 1 and 1A include the respective regions defined by the outer edges of the connecting bodies 53b and 55b as viewed from the direction D1. The areas of the respective regions defined by the outer edges of the connecting bodies 53b and 55b as viewed from the direction D1 are larger than the areas of the respective regions defined by the outer edges of the conductors 53a and 55a as viewed from the direction D1.

Therefore, in the coil components 1 and 1A, the connection strength between the coil 5 and the internal conductors 6 and 7 can be improved as compared with a coil component in which the wirings 53 and 55 that do not include the connecting bodies 53b and 55b and the internal conductors 6 and 7 are connected.

As described above, the connecting bodies 53b and 55b are adjacent to the wiring 51. The portions 531 and 551 of the connecting bodies 53b and 55b include respective regions overlapping the conductors 53a and 55a as viewed from the direction D1, and are adjacent to the wiring 51. The portions 532 and 552 of the connecting bodies 53b and 55b are adjacent to the wiring 51 with the portions 531 and 551 positioned therebetween, and do not overlap the conductors 53a and 55a as viewed from the direction D1. The portions 532 and 552 of the connecting bodies 53b and 55b do not overlap the conductors 53a and 55a. The portions 531 and 551 are positioned between the wiring 51 and the portion 532 and 552. Therefore, a distance between the wiring 51 and each of the portions 532 and 552 is larger than a distance between the wiring 51 and each of the portions 531 and 551. In the configuration in which the portions that do not overlap the conductors 53a and 55a are positioned only between the wiring 51 and each of the portions 531 and 551, a distance between the wiring 51 and each of the portions that do not overlap the conductors 53a and 55a is smaller than the distance between the wiring 51 and each of the portions 531 and 551. Therefore, as compared with the configuration in which the portions that do not overlap the conductors 53a and 55a are positioned only between the wiring 51 and each of the portions 531 and 551, the coil components 1 and 1A are less likely to cause stray capacitance between the wiring 51 and each of the wirings 53 and 55. As a result, the coil components 1 and 1A can restrain an increase in stray capacitance.

In the coil components 1 and 1A, the respective widths between the outer edges of the conductors 53a and 55a as viewed from the direction D1 and the outer edges of the connecting bodies 53b and 55b as viewed from the direction D1 are the largest at the portions 532 and 552.

In the coil components 1 and 1A, as compared with the configuration in which the respective widths between the outer edges of the conductors 53a and 55a as viewed from the direction D1 and the outer edges of the connecting bodies 53b and 55b as viewed from the direction D1 are the largest at the portions 531 and 551, the number of conductors positioned between the wiring 51 and the respective regions overlapping the conductors 53a and 55a of the connecting bodies 53b and 55b as viewed from the direction D1 is smaller. Therefore, in the coil components 1 and 1A in which the respective widths between the outer edges of the conductors 53a and 55a as viewed from the direction D1 and the outer edges of the connecting bodies 53b and 55b as viewed from the direction D1 are the largest at the portions 532 and 552, stray capacitance is less likely caused between the wiring 51 and the wirings 53 and 55. As a result, the coil components 1 and 1A can further restrain an increase in stray capacitance.

In the coil component 1, a length of the region in the direction D2 adjacent to the wiring 51 with the portion 531 positioned therebetween in the direction D2, is larger than a length of the region in the direction D3 adjacent to the wiring 51 with the portion 531 positioned therebetween in the direction D3.

The configuration in which the length of the region in the direction D2 adjacent to the wiring 51 with the portion 531 positioned therebetween in the direction D2 is larger than the length of the region in the direction D3 adjacent to the wiring 51 with the portion 531 positioned therebetween in the direction D3 enables an increase in the coil 5 in the direction D3. Since the coil axis of the coil 5 is along the direction D2, the configuration in which the coil 5 is increased in the direction D3 enables an increase in the cross-sectional area of the coil 5. Therefore, for the coil component 1, an increase in the inductance of the coil component 1 can be achieved.

In the coil component 1A, a length of the region in the direction D3 adjacent to the wiring 51 with the portion 531 positioned therebetween in the direction D3, is larger than a length of the region in the direction D2 adjacent to the wiring 51 with the portion 531 positioned therebetween in the direction D2.

The configuration in which the length of the region in the direction D3 adjacent to the wiring 51 with the portion 531 positioned therebetween in the direction D3 is larger than the length of the region in the direction D2 adjacent to the wiring 51 with the portion 531 positioned therebetween in the direction D2 enables an increase in the coil 5 in the direction D2. Since the coil axis of the coil 5 is along the direction D2, the configuration in which the coil 5 is increased in the direction D2 enables an increase in the number of turns of the coil 5. Therefore, an increase in the inductance of the coil component 1A can be achieved.

In the coil components 1 and 1A, the respective regions of the connecting bodies 53b and 55b that do not overlap the conductors 53a and 55a as viewed from the direction D1 are not disposed between the wiring 51 and the respective regions of the connecting bodies 53b and 55b that overlap the conductors 53a and 55a as viewed from the direction D1.

In the coil components 1 and 1A, as compared with a configuration in which the respective regions that do not overlap the conductors 53a and 55a of the connecting bodies 53b and 55b as viewed from the direction D1 are disposed between the wiring 51 and the respective regions that overlap the conductors 53a and 55a of the connecting bodies 53b and 55b as viewed from the direction D1, the number of conductors positioned between the wiring 51 and the respective regions that overlap the conductors 53a and 55a of the connecting bodies 53b and 55b as viewed from the direction D1 is smaller. Therefore, in the coil components 1 and 1A in which the respective regions of the connecting bodies 53b and 55b that do not overlap the conductors 53a and 55a as viewed from the direction D1 are not disposed between the wiring 51 and the respective regions of the connecting bodies 53b and 55b that overlap the conductors 53a and 55a as viewed from the direction D1, stray capacitance is less likely caused between the wiring 51 and the wirings 53 and 55. As a result, the coil components 1 and 1A can further restrain an increase in stray capacitance.

As described above, the present invention has been described in detail based on the embodiment and modification thereof. However, the present invention is not limited to the above-described embodiment and modification. The present invention can be variously modified without departing from the scope thereof.

The external conductors 3 and 4 may be disposed on the main surface 2a. As viewed from the direction D1, the external conductors 3 and 4 may overlap the corner portions or the ridge line portions between the main surface 2a and the side surfaces 2c, 2d, 2e and 2f. The external conductors 3 and 4 may be exposed at the side surfaces 2c, 2d, 2e, and 2f.

At least one of the wiring 53 or the wiring 55 may include the third wiring. At least one of the wiring 53 or the wiring 55 may include the connecting body.

The conductors 53a and 55a of the wirings 53 and 55 are not limited to the portions closer to the main surface 2b than the wiring 51 in the direction D1. The conductors 53a and 55a of the wirings 53 and 55 may be portions positioned farther away from the main surface 2b than the wiring 51 in the direction D1. The conductors 53a and 55a are portions connected to the conductors 52a and 52e positioned at ends in the direction D2, among the plurality of conductors 52a, 52b, 52c, 52d, and 52e, and may be portions other than the connecting bodies 53b and 55b.

The shortest distance between the main surface 2b and the connecting bodies 53b and 55b may not be equal to the shortest distance between the wiring 51 and the main surface 2b. The shortest distance between the main surface 2b and the connecting bodies 53b and 55b may be smaller than the shortest distance between the wiring 51 and the main surface 2b, or may be larger than the shortest distance between the wiring 51 and the main surface 2b.

The respective widths between the outer edges of the conductors 53a and 55a as viewed from the direction D1 and the outer edges of the connecting bodies 53b and 55b as viewed from the direction D1 may be the largest at the portions 531 and 551. The respective widths between the outer edges of the conductors 53a and 55a as viewed from the direction D1 and the outer edges of the connecting bodies 53b and 55b as viewed from the direction D1 should not be zero in the portions 532 and 552.

As viewed from the direction D1, the portions 531 and 551 may include portions that do not overlap the conductors 53a and 55a. Portions that do not overlap the conductors 53a and 55a of the portions 531 and 551 may be positioned between the wiring 51 and the portions 531 and 551.

The portions 532 and 552 may include at least one of the respective regions adjacent to the wiring 51 with the portions 531 and 551 positioned in the direction D2 or the respective regions adjacent to the wiring 51 with the portions 531 and 551 positioned in the direction D3. The portions 532 and 552 may include the respective regions adjacent to the wiring 51 with the portions 531 and 551 positioned in the direction D2 and the respective regions adjacent to the wiring 51 with the portions 531 and 551 positioned in the direction D3.

The coil axis of the coil 5 may be provided along the direction D3. The plurality of conductors 52a, 52b, 52c, 52d, and 52e may be arranged in the direction D3.

As understood from the description of the above-described embodiment, the present specification includes the disclosure of the following aspects.

The coil component includes a pair of external conductors including the external conductor and a pair of internal conductors including the internal conductor. The pair of external conductors is exposed at the first main surface. The pair of internal conductors is disposed between the pair of external conductors and the coil in the first direction, and connects the pair of external conductors and the coil. The coil has a pair of third wirings including the third wiring. The pair of third wirings respectively connects a pair of second conductors positioned at both ends in the second direction, among a plurality of second conductors, and the pair of internal conductors.

The first wiring is positioned between a first portion included in one third wiring of the pair of third wirings and a first portion included in another third wiring of the pair of third wirings. A second portion included in the one third wiring of the pair of third wirings and a second portion included in the other third wiring of the pair of third wirings are not positioned between the first portion included in the one third wiring of the pair of third wirings and the first portion included in the other third wiring of the pair of third wirings. The first portion included in the one third wiring of the pair of third wirings and the first portion included in the other third wiring of the pair of third wirings are positioned between the second portion included in the one third wiring of the pair of third wirings and the second portion included in the other third wiring of the pair of third wirings.

What is claimed is:

1. A coil component comprising:
an element body having a first main surface and a second main surface opposed to each other in a first direction;
an external conductor exposed at the first main surface;
a coil in the element body;
an internal conductor disposed between the external conductor and the coil in the first direction, and connecting the external conductor and the coil, wherein
the coil has
a first wiring including at least one first conductor adjacent to the first main surface,
a second wiring adjacent to the second main surface and including a plurality of second conductors arranged in a second direction intersecting the first direction, and
a third wiring connecting the internal conductor and a second conductor positioned at an end in the second direction among the plurality of second conductors, wherein
the third wiring includes
a connecting body positioned on the internal conductor and adjacent to the first wiring, and
a third conductor extending along the first direction between the connecting body and the second conductor positioned at the end, wherein
the connecting body includes
a first portion adjacent to the first wiring and including a region overlapping the third conductor as viewed from the first direction, and
a second portion not overlapping the third conductor as viewed from the first direction and adjacent to the first wiring, with the first portion positioned between the second portion and the first wiring, and
an area of a region defined by an outer edge of the connecting body as viewed from the first direction is larger than an area of a region defined by an outer edge of the third conductor as viewed from the first direction.

2. The coil component according to claim 1, wherein
a width between the outer edge of the third conductor as viewed from the first direction and the outer edge of the connecting body as viewed from the first direction is the largest at the second portion.

3. The coil component according to claim 2, wherein
the second portion includes at least one of
a region adjacent to the first wiring with the first portion positioned between the second portion and the first wiring in the second direction, or
a region adjacent to the first wiring with the first portion positioned between the second portion and the first wiring in a third direction intersecting the first direction and the second direction.

4. The coil component according to claim 3, wherein
a length of the region in the second direction adjacent to the first wiring with the first portion positioned between the second portion and the first wiring in the second direction is larger than a length of the region in the third direction adjacent to the first wiring with the first portion positioned between the second portion and the first wiring in the third direction.

5. The coil component according to claim 3, wherein
a length of the region in the third direction adjacent to the first wiring with the first portion positioned between the second portion and the first wiring in the third direction is larger than a length of the region in the second direction adjacent to the first wiring with the first portion positioned between the second portion and the first wiring in the second direction.

6. The coil component according to claim 1, wherein
a region of the connecting body not overlapping the third conductor as viewed from the first direction is not positioned between the first wiring and the region overlapping the third conductor as viewed from the first direction.

7. A coil component comprising:
an element body having a first main surface and a second main surface opposed to each other in a first direction;
an external conductor exposed at the first main surface;
a coil in the element body;
an internal conductor disposed between the external conductor and the coil in the first direction, and connecting the external conductor and the coil, wherein
the coil has
a first wiring including at least one first conductor adjacent to the first main surface,
a second wiring adjacent to the second main surface and including a plurality of second conductors arranged in a second direction intersecting the first direction, and
a third wiring connecting the internal conductor and a second conductor positioned at an end in the second direction among the plurality of second conductors, wherein
the third wiring includes
a connecting body positioned on the internal conductor and adjacent to the first wiring, and
a third conductor extending along the first direction between the connecting body and the second conductor positioned at the end, wherein
the connecting body includes
a first portion adjacent to the first wiring and including a region overlapping the third conductor as viewed from the first direction, and
a second portion spaced apart from the third conductor as viewed from the first direction and adjacent to the first wiring, with the first portion positioned between the second portion and the first wiring, and
an area of a region defined by an outer edge of the connecting body as viewed from the first direction is larger than an area of a region defined by an outer edge of the third conductor as viewed from the first direction.

8. The coil component according to claim 7, wherein
a width between the outer edge of the third conductor as viewed from the first direction and the outer edge of the connecting body as viewed from the first direction is the largest at the second portion.

9. The coil component according to claim 8, wherein
the second portion includes at least one of
a region adjacent to the first wiring with the first portion positioned between the second portion and the first wiring in the second direction, or
a region adjacent to the first wiring with the first portion positioned between the second portion and the first wiring in a third direction intersecting the first direction and the second direction.

10. The coil component according to claim 9, wherein
a length of the region in the second direction adjacent to the first wiring with the first portion positioned between the second portion and the first wiring in the second direction is larger than a length of the region in the third direction adjacent to the first wiring with the first portion positioned between the second portion and the first wiring in the third direction.

11. The coil component according to claim 9, wherein
a length of the region in the third direction adjacent to the first wiring with the first portion positioned between the second portion and the first wiring in the third direction is larger than a length of the region in the second direction adjacent to the first wiring with the first portion positioned between the second portion and the first wiring in the second direction.

12. The coil component according to claim 7, wherein
a region of the connecting body spaced apart from the third conductor as viewed from the first direction is disposed only at a position farther from the first wiring than is the region overlapping the third conductor as viewed from the first direction.
